(19) United States
(12) Patent Application Publication
(10) Pub. No.: US 2010/0093345 A1
(43) Pub. Date: Apr. 15, 2010

(54) MOBILE NETWORK, MOBILE NETWORK BASE STATION AND METHOD TO REGISTER A MOBILE TERMINAL ON A NETWORK

(76) Inventors: Dirk Antoine Verhoef, Rijnsburg (NL); Matthijs Klepper, Oegstgeest (NL); Theodorus Johannes Peter Van Nuland, Schiedam (NL)

Correspondence Address: MICHAELSON & ASSOCIATES, P.O. BOX 8489, RED BANK, NJ, 07701-8489, US

(21) Appl. No.: 12/448,321

(22) PCT Filed: Dec. 7, 2007
(86) PCT No.: PCT/EP2007/010651

§ 371 Date: Dec. 7, 2009

Related U.S. Application Data
(60) Provisional application No. 60/876,873, filed on Dec. 22, 2006.

(51) Int. Cl. H04W 8/06; H04W 4/00

(52) U.S. Cl. 455/433; 455/435.2

(57) ABSTRACT

A mobile network, configured to broadcast at least a first network identity and a second network identity, particularly to provide a first and a second network layer. Also, a method is provided to register a mobile terminal on a network, having the steps of broadcasting, via the network the first and second network identities; receiving the network identities and registering the mobile terminal on the network when a received network identity corresponds with an individual mobile subscriber identity (IMSI) of a respective subscriber of the terminal.

### BACKGROUND OF THE INVENTION

1. Field of the Invention

The invention relates to a mobile network. The invention also relates to a mobile network base station, to a method to register a mobile terminal on a network, a method to provide a mobile network and the use of such method.

2. Description of the Prior Art

In the present application, it is assumed that the skilled reader has some common general knowledge with regard to mobile network technology. This application uses various acronyms, all of which are defined at the end of the application. The following concepts as such are assumed to be known to the skilled reader:
General architecture of mobile networks in terms of core network elements like MSC, GMSC, SGSN, GGSN, HLR, etc., radio network elements like BSC and base stations and transmission between network elements;
General functionality of mobile networks with regard to mobility features;
General accepted terminology in mobile network technology, mainly based on generally used ETSI and 3GPP specifications of mobile networks;
General understanding of planning aspects of mobile networks, like radio cell planning, capacity and quality;
General knowledge and general accepted terminology with regard to identities used in mobile network, like IMSI, PLMN codes, HPLMN, et cetera;
General knowledge and general accepted terminology with regard to mobile user equipment. Examples: mobile terminal, UE, MS, SIM;
General understanding of interworking between mobile network and mobile user equipment;
Understanding of architecture of base stations, particularly transmitter and receiver combining; and
2G and 3G network specifications in general.

Also known are the 3GPP specifications that contain concepts to broadcast multiple network identities in one physical UMTS network, see, e.g., “‘TS 23.251 V6.4.0 Network Sharing; Architecture and functional description’, 3GPP specification, June 2005”.

As much as possible general accepted terminology in the mobile telecommunication industry has been used throughout the description.

When two mobile networks merge, e.g., as a result of one mobile telecommunications company taking over another telecommunications company, it is possible to switch off (parts of) the network infrastructure of one of the companies and transfer the customers to the remaining network, which most probably must be expanded in terms of capacity.

Taking over of an ‘alien’ customer base (i.e., customers from another network, i.e., “absorption”) in a mobile network is not trivial. Several obvious methods are available, such as national roaming or swapping equipment at the customer. It occurs that those methods have severe drawbacks in terms of cost and customer impact.

The following describes the problems of the prior art. To understand the problem, various aspects about networks and their use of identities will be explained. This is done in the following section “Use of identities in separate networks”.

Use of Identities in Separate Networks

First, two separate networks are considered, see FIG. 1. Network 1 (a first network; particularly radio network 1 of a first network) is broadcasting the network identity or Home Public Land Mobile Network, in this case HPLMN1. A HPLMN exists of a Mobile Country Code (MCC) and Mobile Network Code (MNC). In order to be able to use this network, a subscriber requires a SIM (particularly a SIM card), containing the Individual Mobile Subscriber Identity (IMSI) of the subscriber. The IMSI is a unique identifier, which contains also the MCC and MNC. In case the IMSI of the SIM corresponds with the received HPLMN of the network, the terminal will try to register on the network by sending a registration request. In case the IMSI is administratively registered in the network, the network will permit the terminal to use the network by sending a positive acknowledgement.

Ideal Requirements

The following requirements are ideal requirements in order to discard parts or the whole of one network and still serve, through another network, the (original) subscribers of the former network. In order to discard one network in favor of the other and still serve the migrated subscribers, the ideal requirements are as follows:
Subscribers do not need to change their equipment, i.e., there is no need to swap either mobile terminal or SIM.
The subscribers are automatically transferred from one network to the other network, i.e., the subscribers are not involved in the actual migration.
After migration, the migrated subscribers do not experience any difference with regard to functionality, i.e., continuity of services is guaranteed.
After migration, the migrated subscribers do not experience any difference with regard to brand names (particularly of network operators) in the display of the terminal.
At least one radio network is discarded. Core network elements are discarded as much as possible.

The following two solutions reveal certain bottlenecks.

“Sub Optimal Solution: National Roaming”

National Roaming is a sub-optimal prior art solution. Consider a subscriber from network 2 (i.e., a second network), which would like to use network 1 (i.e., a first network). This has been visualized in FIG. 2. Only some (small) core elements of network 2 need to be in place to realize this. The major part of network 2, i.e., the entire radio network 2 and most of the core network 2 elements can be switched off.

This concept is called National Roaming and is possible if the following conditions are met:

1. The networks 1 and 2 must be connected to each other.

2. Network 1 should allow the ‘visitor’ (i.e., the subscriber from network 2) to register. Hereto, in the case of national roaming a copy of information of the subscriber is sent from network 2 to network 1.

3. The SIM of subscriber should not have network 1 marked as ‘forbidden’, i.e., should not have network 1 stored in a Forbidden PLMN list (FPLMN) that is stored on the SIM. A network is marked as forbidden if once an attempt to register on that network has been made, a negative acknowledgement of that particular network has occurred. Usually, if two competitive networks exist in one common area, each network is marked as forbidden on a SIM programmed to operate on the other network.

Other implementation variants are possible, for instance migrating the service platforms and HLR from network 2 to network 1.

Various disadvantages arise from the national roaming solution:
The main problem is to get PLMN 1 cleared of the forbidden PLMN list of subscribers of network 2. It is possible to use an Over The Air transmission (OTA) (particularly to update the FPLMN list), but this is not possible for the entire subscriber base. It is also possible to have the subscribers manually select network 1, but this disadvantageously burdens and thus negatively impacts the customer.
Brand names (of network operators) in the display of mobile terminals are not guaranteed or not guaranteed to be correct (see below concerning FIG. 14 for an explanation).
Inbound roamers on network 2 can no longer be served, hence causing a loss of revenue to the network service provider.
Border roaming interferes with the solution: international roaming partners have networks that equally attract subscribers of network 2 and network 1 (particularly because the HPLMN of the subscribers no longer is in place).
Due to the lack of a HPLMN for subscribers of network 2 (particularly caused by the switching off of network 2), the terminals will regularly attempt to find their HPLMN, which results in substantial additional battery consumption of the terminal and possible short periods of inaccessibility of the terminals.

“Sub Optimal Solution: SIM Swap”

Another sub-optimal prior art solution is simply to swap the SIM and/or terminal of the subscribers, as explained below in conjunction with FIG. 3.

Drawbacks of this SIM swap solution are:
Unwanted impact at/to subscribers: all SIMS of all subscribers must be replaced. Moreover, the number of terminals with a SIM lock is high, so the SIM locks have to be removed as well. The expenses and organizational effort involved to accomplish this are huge.
To solve display problems (particularly display problems with displaying brand names), a portion of the installed terminal base should be replaced. Reference is made to the explanation of FIG. 14 for the background of display problems.
Billing and provisioning chains (IT systems) and corresponding processes of each network must also be extensively modified.

3G Solution

A known 3G solution (see the 3GPP specifications) is based on one carrier, where synchronization between the network and terminal is always based on one PLMN (‘mother PLMN’) and where the other PLMNs are broadcasted as information elements on the mother PLMN. Also, the 3GPP 3G solution is aimed at use of ‘supporting UEs (supporting User Equipments)’, whereas special arrangements have been made to support also ‘non-supporting UEs’.

### SUMMARY OF THE INVENTION

The present invention aims to alleviate the above-mentioned problems. Particularly, the invention provides a means and method for taking over ‘alien’ customers in a mobile network, that minimizes customer impact.

According to an embodiment of the invention, a mobile network is provided and which is configured to broadcast at least a first network identity and a second network identity. The network provides a first and a second network layer.

Consequently, the mobile network (having a first network identity) can provide the means which, e.g., take over ‘alien’ customers in order to migrate users of a second network (having a second network identity) to a first network (having a first network identity). Particularly, the mobile network is an existing mobile network, such as one which already broadcasts the first network identity, but has been reconfigured to also broadcast at least the second network identity.

According to an embodiment of the invention, the present network can broadcast at least a first and second network identity, for example utilizing respective network layers, so that customer impact can be minimized. Also, the present invention can achieve a relatively large number of the above-mentioned ideal requirements. The invention can be implemented to prevent changing or reconfiguring user equipment, and eliminates any need for any of the subscribers to be personally involved in a network migration. Also, the migrated subscribers do not have to experience any functional differences as a result of being migrated across the two networks. Preferably, migrated subscribers also do not experience any difference with regard to brand names displayed on their terminals. Also, the invention can lead to discarding of at least one radio network, wherein core elements of the discarded network can themselves also be significantly discarded.

According to a further embodiment, the network can be a Home Public Land Mobile Network (HPLMN), the first network identity (HPLMN1) being a first Home Public Land Mobile Network code, and the second network identity (HPLMN2) being a second Home Public Land Mobile Network code.

According to a preferred embodiment of the invention, the network can have a network architecture configured to provide a first layer relating to the first network identity and a second layer relating to the second network identity. The layers are preferably separate and independent.

According to an embodiment of the invention, a mobile network base station is provided, when the station has a number of first transceivers, configured for a first network layer relating to a first network identity, and a number of second transceivers configured for a second network layer relating to a second network identity.

Also, according to an embodiment of the invention, a mobile network base station is provided, when the station has a number of first transceivers, configured for a first network layer relating to a first network identity, and a cross-connect to share transmission with a second base station, the second base station having a number of second transceivers configured for a second network layer relating to a second network identity.

Also, the present invention provides a method to register a mobile terminal on a network, for example a network according to the invention, the method having the steps of:
the network broadcasting at least a first network identity and a second network identity;
the mobile terminal receiving the network identities; and
registering the mobile terminal on the network when a received network identity corresponds with an individual mobile subscriber identity of a respective subscriber of the terminal.

According to an embodiment, there is also provided a method to provide a mobile network, having the steps of:
providing a first mobile network configured to broadcast a first network identity, using a respective first network layer; and
providing the first mobile network, with at least a second network layer, for using a second network identity relating to an alien network.

Preferably, a multiple-layer network architecture is used in the first network to discard a second, alien, network.

Also, the method can have the additional step of:
maintaining perception of a certain user that ‘his’ or ‘her’ particular layer is used, by keeping the respective user terminal in an idle mode on that particular layer by blocking layer transition during the idle mode.

A method according to the invention can be used advantageously where the second network layer is provided for taking over alien customers in the first mobile network, the second network identity is broadcast on the first network, with the second identity being equal to the alien network identity.

A basic idea of the invention is the insight to provide a multiple-layer mobile network to, e.g., overtake an alien network.

The inventive method can also be called a ‘multiple-layer mobile network’ method. This method can be most useful to 2G mobile networks, but can also be used in other networks like 3G mobile networks. In a nutshell, according to an embodiment of the invention, in an existing network, a second network identity is broadcast, which equals the alien network identity.

In contrast to the known 3G solution, the present invention can advantageously reserve separate carriers and separate BCCHs for each 2G layer, whereas the known 3G solution is based on one carrier where synchronization between network and terminal is always based on one PLMN (‘mother PLMN’) and where the other PLMNs are broadcasted as information elements on the mother PLMN.

2G specifications (3GPP/ETSI) do not contain any feature for network sharing. However, certain embodiments of the present invention advantageously do.

Implementation of proprietary network sharing features is not available in known solutions. However, the invention can advantageously enable this.

Implementation of embodiments of the present invention can advantageously lead to a network, which from point of view of a terminal and/or an end user, behaves entirely equal to the old switched off network (for example, a taken over alien network). In the known 3GPP 3G solution on the other hand, that solution is aimed at use of ‘supporting UEs’, and, as such, special arrangements have been made to also support ‘non-supporting UEs’.

Further advantageous embodiments of the invention are described in the dependent claims. These and other aspects of the invention will be apparent from and elucidated with reference to non-limiting embodiments described hereafter, shown in the drawings.

### BRIEF DESCRIPTION OF THE DRAWINGS

FIG. 1 schematically depicts a conventional arrangement of two separate mobile networks and their use of identities;

FIG. 2 depicts a first prior art solution, of roaming with highly integrated networks;

FIG. 3 depicts a second prior art solution of a SIM swap;

FIG. 4 schematically shows an architecture of two separate networks;

FIG. 5 shows a first embodiment of the present invention, depicting an architecture of a dual-layer GSM network;

FIG. 6 shows a second embodiment of the present invention, depicting an architecture of a dual-layer GSM network with a separate core CS network variant;

FIG. 7 shows a third embodiment of the present invention depicting an architecture with three layers;

FIG. 8 shows a unidirectional CS traffic steering from layer 2 to layer 1;

FIG. 9 shows a Bi-directional Traffic steering;

FIG. 10 shows an embodiment of the present invention implemented in an existing base station;

FIG. 11 shows an embodiment of the present invention implemented with an additional base station;

FIG. 12 shows an embodiment of the present invention implemented with an additional base station and extended combiner;

FIG. 13 shows an embodiment of the present invention implemented with an additional base station and a separate antenna;

FIG. 14 schematically shows an embodiment of various items which can be displayed on a mobile terminal; and

FIG. 15 shows a traffic steering state diagram.

### DETAILED DESCRIPTION

Similar or corresponding features in two or more figures are denoted by similar or corresponding reference insignia.

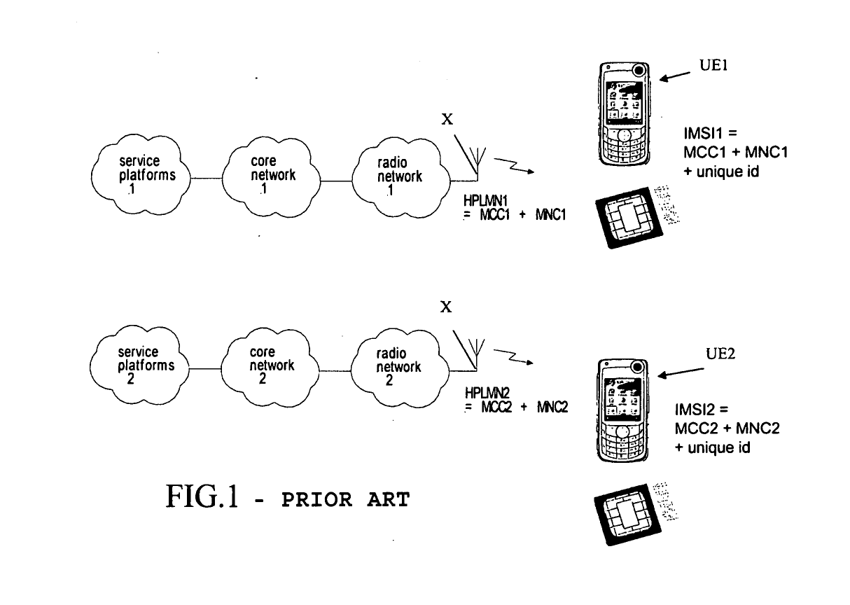

FIG. 1 shows an embodiment of a prior art system, wherein a first Home Public Land Mobile Network broadcasts a first network identity HPLMN1, and a second Home Public Land Mobile Network broadcasts a second network identity HPLMN2. The first network identity HPLMN1 contains a first Mobile Country Code MCC1 and a first Mobile Network Code MNC1. The second network identity HPLMN2 contains a second Mobile Country Code MCC2 and a second Mobile Network Code MNC2. Each of the networks may illustratively contain a radio network having one or more antennas X, a core network and service platforms, all as will be appreciated by a skilled person in the art. A first user terminal UE 1 of a network subscriber of the first network requires a SIM containing a first Individual Mobile Subscriber Identity IMSI1 of the subscriber, the IMSI1 itself containing the first Mobile Country Code MCC1 and the first Mobile Network Code MNC1. A second user terminal UE 2 of a network subscriber of the second network requires a SIM containing a second Individual Mobile Subscriber Identity IMSI2 of the subscriber, where the IMSI2 itself contains the second Mobile Country Code MCC2 and the second Mobile Network Code MNC2.

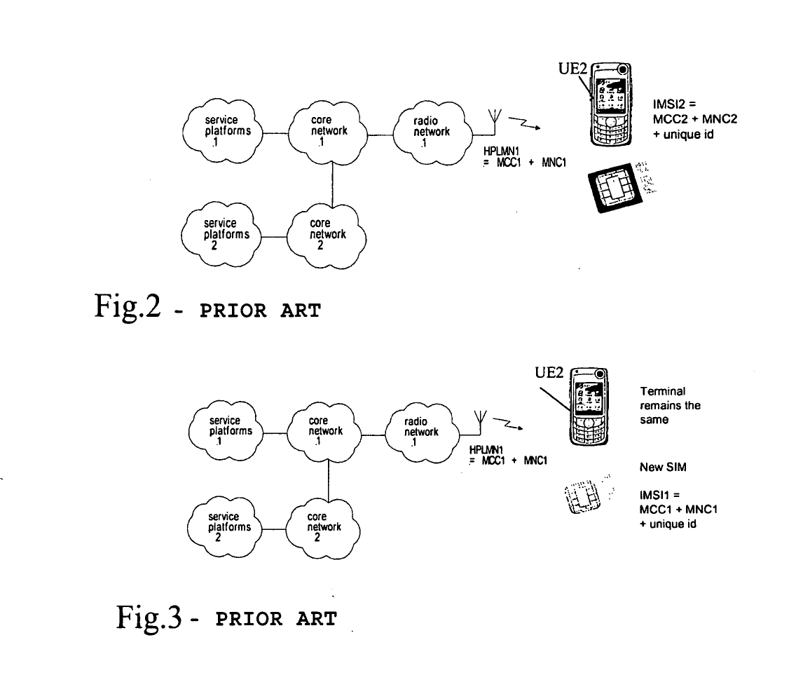

FIG. 2 shows an example of prior art embodiment, called National Roaming, where a subscriber from the second Home Public Land Mobile Network would like to use the first Home Public Land Mobile Network. To this aim, the SIM of the subscriber should not have the first network marked as ‘forbidden’. Also, the first network is configured to allow the visitor (i.e., the second user terminal UE2) to register. In the embodiment shown in FIG. 2, only some (small) core elements of the second network are in place and are coupled to the core network of the first network. A radio network part of the second network can be switched off.

FIG. 3 shows an embodiment of a known SIM swap method. In this case, the second terminal UE2 that was previously used by the user to register on the second network is being reconfigured by the user to register on the first network. This is achieved by installing a new SIM in the second terminal UE2, where the second SIM contains the first Individual Mobile Subscriber Identity IMSI1.

Disadvantages concerning the solutions shown in FIGS. 1-3 have been described above.

Display Problem

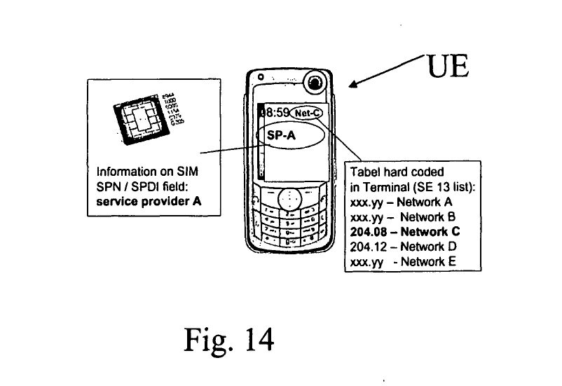

The following section explains how brand names of mobile operators are shown in a display of a mobile terminal UE (see FIG. 14). Furthermore, a clarification is given with regard to the brand name problems in the display in case National Roaming or a SIM swap is deployed.

On a mobile terminal, two potential ways exist to display a brand name on the display of a mobile terminal:

1. SE13 List in Terminal.

In the terminal, a table is available which relates the received PLMN code of the network to a brand name. This is called the “SE13 list”. As shown in FIG. 14, the terminal UE is camping on a network with MCC 204 and MNC 08 (the latter two are not specifically shown), and therefore “Net-C” for Network C is displayed. This field is originally meant to display the name of the network operator. This list can only modified by loading new firmware into the terminal. Old, as well as currently available terminals, have this functionality.

2. SPN Field on SIM.

On the SIM, a Service Provider Name (SPN) filed is available which can be programmed to display a second brand name. Terminal UE is using service provider A, and therefore “SP-A” is displayed. This field is originally meant to show the brand name of a service provider which uses capacity of a certain network operator. This name can be changed by reprogramming the name on the SIM. This reprogramming can be remotely done, via the network, by Over The Air (OTA) transmission. Very old SIMs do not have the SPN name available, however recent and currently available SIMs have this functionality. Furthermore, the correct working of a available SPN field on SIM requires the mobile terminal to support this functionality.

With regard to which name to display, either SE13 name, SPN name or both, different situations must be distinguished. According ETSI/3GPP specifications, two cases exist:

1. HPLMN

The terminal is camping on a HPLMN, i.e., PLMN of the network corresponds with HPLMN of the IMSI. In this case, the SPN name prevails, i.e., in case SPN functionality is available on SIM and terminal, only the SPN name is shown. If SPN functionality is not available, then the SE13 name is shown.

2. Roaming

Here, the terminal is camping on a network with a PLMN code which does not correspond with the HPLMN code of the IMSI. In this case, both names are always shown on the display. The reason for this is that, in international roaming, it should be clear to a customer which network is used due to more expensive mobile services. Note that from a technical point of view, international roaming and national roaming are equal.

With this knowledge in mind, the reasons behind the display problems can be clarified. The starting point is a network which absorbs customers and might be displayed due to the SE13 list.

1. Prior Art National Roaming Solution (See Above).

In this case, either the SE13 name is shown or the SE13 and SPN names are shown. With the SPN name (to be influenced via OTA) something can be done to get a correct name in the display after migration, however a full solution is not available because the brand name of the receiving network will always be shown.

2. Prior Art SIM Swap Solution (See Above)

In this case, either the SE13 name is shown for older terminals and SIMs, or the SPN name is shown for newer terminals and SIMs. Because older terminals still constitute a substantial part of the installed customer base, a full solution cannot be achieved with a SIM swap.

Considerations

Consider, e.g., two 2G networks, each with a separate customer base. Each customer base has access to unique end user services. Each customer base is offered a certain network quality in terms of coverage and capacity.

In order to overcome drawbacks of the prior art, the radio interface preferably remains the same for both customer bases. The main question now is: ‘How is it possible to retain two separated radio interfaces and share network elements to the most optimal extent and with continuity of end user services and network quality for each customer base?’

The next sections will describe embodiments according to the invention, through which a high extent of network sharing is achieved while having full continuity of end user services and with controllable network quality.

General Description of Two-Layer Architecture

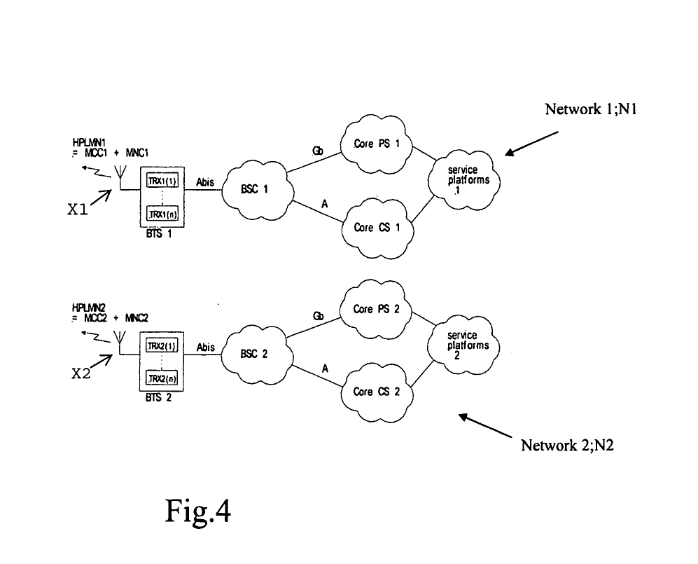

Refer to FIG. 4 to understand a network architecture of two separate networks and at a level convenient to explain the inventive concept.

As will be appreciated by the skilled person,

FIG. 4 shows a first network (“network 1”; N1), having first service platforms, a first Core PS and first Core CS both coupled to a first Base Station Controller BSC1 via respective interfaces (the A and Gb interfaces). The first Base Station Controller BSC1 is coupled to a first base station BTS1 (via the Abis interface). The first base station BTS1 contains a number, n, of first transceivers (i.e., transmitter-receivers) TRX1(1) . . . . TRX1(n), being provided with one or more first antenna or radio interface X1, for communication with user equipment UE (not shown), to, e.g., transmit and receive a first network identity HPLMN1.

FIG. 4 also shows a second network (“network 2”; N2) containing second service platforms, a second Core PS and second Core CS, both coupled to a second Base Station Controller BSC2 via respective A and Gb interfaces. The second Base Station Controller BSC2 is coupled to a second base station BTS2 (via the respective Abis interface). The second base station BTS2 has a number, n, of second transceivers TRX2(1) . . . . TRX2(n), being provided with one or more second antenna or radio interface X2, for communication with user equipment UE (not shown), to, e.g., transmit and receive a second network identity HPLMN2.

### First Embodiment

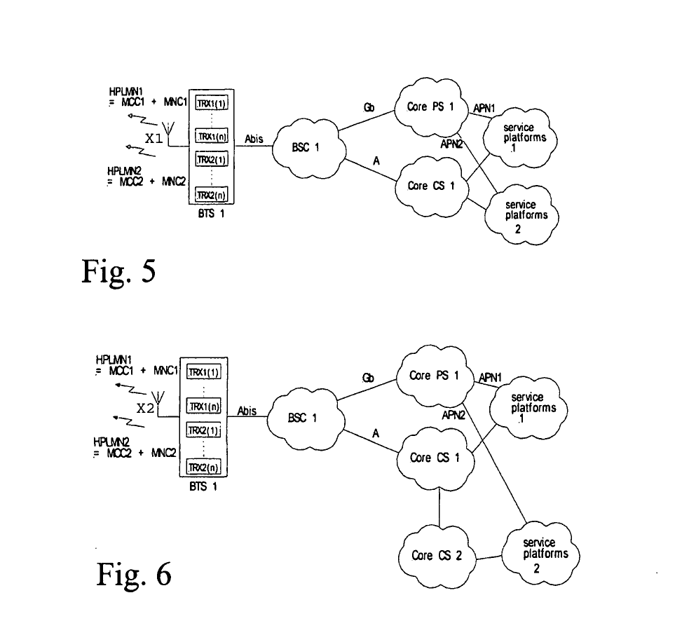

According to an embodiment of the invention, the inventive concept relies on configuring at least one separate first transmitter-receiver (TRX1) (and preferably each) in the base station BTS1 of the first network to such an extent that first transmitter-receiver behaves on the first radio interface/antenna X1 as would a transceiver TRX2 of the second network. This is shown in FIG. 5. Also, more TRXs may be configured as second network TRXs, however at least one of those TRXs is preferably configured as BCCH TRX (broadcast channel TRX). This BCCH TRX continuously transmits pilot channels and broadcast channels during its operation, and amongst the PLMN code. Via this TRX, terminals UE are also able to register in the network.

Specifically, FIG. 5 shows an embodiment of the present invention having a (single) mobile network configured to broadcast a first network identity HPLMN1 and a (different) second network identity HPLMN2 to provide a first and a second network layer. Here, the network is a Home Public Land Mobile Network (HPLMN), the first network identity HPLMN1 is a first Home Public Land Mobile Network code, and the second network identity HPLMN2 is a second Home Public Land Mobile Network code. The depicted embodiment has a Base Station BTS1 with a plurality of transceivers TRX1, TRX2 configured to broadcast the first and second network identity. A number, n, of first transceivers TRX1 of the first Base Station are configured to broadcast the first network identity HPLMN1 and a number, n, of transceivers TRX2 of the first Base Station BTS1 are configured to broadcast the second network identity HPLMN2. The number of first transceivers TRX1 can differ from the number of second transceivers TRX2 as will be appreciated by the skilled person in the art.

The network also has a first antenna (radio interface) X1 to transmit both the first and second network identities HPLMN1, HPLMN2. Thus, the same radio interface can be used to transmit both of those identities.

Also, the present network particularly has a network architecture configured to provide a first layer relating to the first network identity HPLMN1 and a second layer relating to the second network identity HPLMN1 where the layers are separate and independent.

As shown in FIG. 5, the network also has a Base Station Controller BSC1 connected to the Base Station BTS1 via an interface (Abis), where the Base Station Controller BSC1 is configured to handle the two network codes HPLMN1 and HPLMN2. The network preferably also has a Mobile Switching Centre (MSC) and Serving GPRS Support Node (SGSN) that are both configured to handle the two network codes HPLMN1 and HPLMN2. The MSC and SGSN are not depicted for clarity, however, the skilled person in the art will appreciate how these network components can be implemented in the present embodiment.

As follows from the above, the first network identity HPLMN1 can contain a first Mobile Country Code MCC1 and a first Mobile Network Code MNC1, where the second network identity HPLMN2 can contain a second Mobile Country Code MCC2 and a second Mobile Network Code MNC2.

Also, the second Mobile Network Code MNC2 is different from the first Mobile Network Code MNC1.

Besides, the network has at least a first service platform (“service platforms 1” in FIG. 5) associated with the first network code HPLMN1 and a second service platform (“service platforms 2”) associated with the second network code HPLMN2.

The network can also comprise a packet switching core (Core PS 1) and a circuit switching core (Core CS 1) where each of the first and second service platforms is connected to the packet switching core (Core PS 1) and to the circuit switching core (Core CS 1) as indicated in FIG. 5. For example, access point names APN1 and APN2 can be transmitted between the network packet switching core (Core PS 1) and respective service platforms.

The embodiment of FIG. 5 can be used to register a mobile terminal UE on a network in the following fashion:
the network broadcasting at least the first network identity HPLMN1 and a second network identity HPLMN2, via the same radio interface X1 of the same base station BTS1, or uses base stations BTS1 and BTS1′ being connected to each other (as shown in FIGS. 11-13), or utilizes the same base station controller BSC1;
the mobile terminal UE receives receiving the network identities;
the mobile terminal is registered on the network when a received network identity (i.e., received by the mobile terminal) corresponds with an individual mobile subscriber identity IMSI of a respective subscriber of the terminal.

A mobile network can be provided as follows:
a first mobile network is provided which is configured to broadcast a first network identity HPLMN1 using a first network layer; and
the first mobile network is provided with a second network layer and uses a second network identity HPLMN2 which relates to an alien network.

As follows from the above, a multiple-layer network architecture is preferably used in the first network to discard a second, alien, network. This can be used in taking over the second network where its subscribers can be migrated to the first network in a simple manner (particularly without having to reconfigure their user equipment UE), resulting, for example, in the network embodiment shown in FIG. 5.

During use, for example, the second network layer can be provided for taking over alien customers in the first mobile network, where in the first network the second network identity (HPLMN2) is broadcast, this second identity is equal to the alien network identity.

As a result, the SIM of each subscriber of a former second network (i.e., the alien network) can have the first network identity marked as ‘forbidden’, but can access the presently provided network via the second network layer (utilizing the second network identity HPLMN2).

Some further embodiments of operation of such a multiple-layer network, particularly regarding advantageous traffic steering embodiments, are shown in FIGS. 8 and 9 (discussed below).

Further, the present invention can also solve the above-mentioned display problem in a relatively efficient manner.

The embodiment shown in FIG. 5 utilizes maximal network sharing. Actually, only TRXs are not shared. Preferably, shared are:
antennas (i.e., radio interfaces X1), including feeders, masthead amplifiers, remote electrical tilt, etc.;
base stations (except TRXs);
transmission on Abis interfaces;
BSCs;
transmission on A and Gb interfaces;
Core network elements: MSCs, SGSNs, GGSNs and HLRs; and
OSS systems.

This embodiment cam function under the following conditions:
base stations can be configured with TRXs, separated by two PLMN codes;
BSCs can handle two PLMN codes;
MSCs can handle two PLMN codes;
SGSNs can handle two PLMN codes; and
frequencies used to configure the second network TRXs fall within the same frequency band used in the first network.

Routing within PS networks, is done simply to add additional Access Points Names to create routes to service platforms as well as outbound routes to other networks. CS routing can be based on analysis of IMSI and B subscriber numbers.

Mobility in network layer 2 (i.e., the second layer) can be arranged in an equal way compared to mobility in (the second) network. Mobility, here entails cell reselections in idle mode, handovers in active mode (circuit switched) and cell reselection for PS services (idle state, ready state and stand by state). Mobility in layer 2 does not interfere with mobility functions in layer 1 (i.e., the first layer). Actually mobility in each layer, “intra PLMN mobility”, can be arranged in the same manner as usually occurs in a one-layer architecture. A condition that needs to be met is that handover and cell reselection mechanism are based on full Cell Global Identity (CGI), i.e., MCC+MNC+LAC+Cell ID. Even only LAC and cell ID can be used, but, with certain restrictions, unique combinations of LAC and Cell ID are used in the different layers.

For PS services, GPRS can be used as well as Edge.

By using the same antenna or radio interface X1, potential coverage of layer 1 and layer 2 (of the network) will be equal. This is generally true, however, for reasons of clarity, not an entire network is represented in FIG. 5. The coverage of each layer of a larger area can be differentiated. How this can be done is described later. Variants of base station implementations can also influence the local coverage of one site.

### Second Embodiment

FIG. 6 shows a second embodiment of the invention which differs from the embodiment of FIG. 5 in that a second Core CS (“Core CS 2”) is provided and which is coupled to the first Core CS (“Core CS 1”) and to second network service platforms (“service platforms 2”).

The second embodiment can be called a “Separate core network variant”. In case a two-layer architecture is used to discard one network, e.g., a second network (Network 2), that architecture can migrate all service platforms from the old core network 2 to the remaining network 1. To circumvent this problem, in the alternative architecture according to FIG. 6, a route to the remaining core network 2 is added. All traffic, based on IMSI can be directed to core network 2.

For PS (Packet Switched), the need to do so is not high so it is rather simple to add APNs and migrate service platforms connected to PS network 2 to PS network 1.

### Third Embodiment

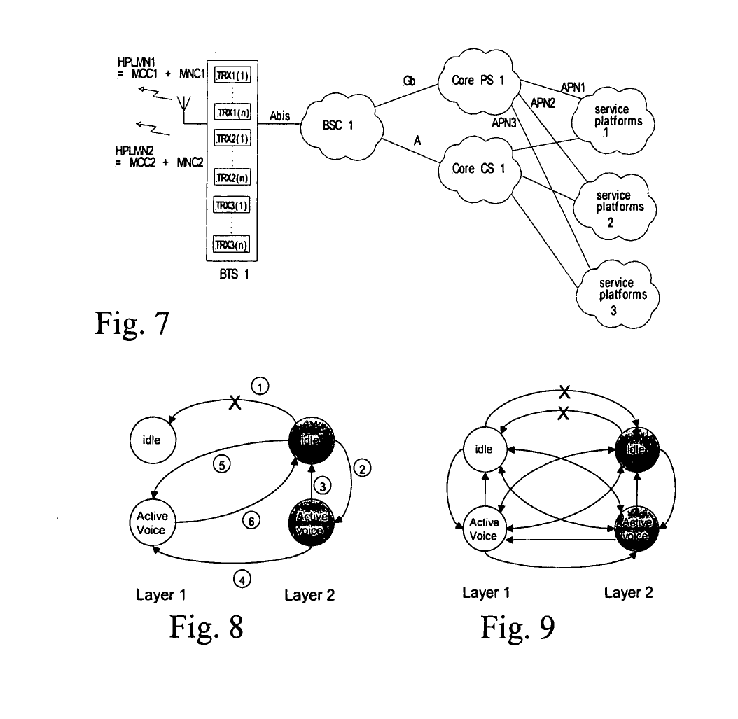

FIG. 7 shows a third embodiment of the invention, which differs from the embodiment shown in FIG. 5 in that a third network layer is provided which relates to a (previous) third network. For example, in FIG. 7, one or more additional third transceivers TRX3 (of the first Base Station) are provided and configured to broadcast a third network identity HPLMN3 (including a third MCC and a third MNC), preferably, again, via the same radio interface and utilizing the same base station controller BSC1. Thus, this yields a three-layer architecture.

As follows from FIG. 7, the concept with two layers (see FIGS. 5 and 6) can be extended with additional layers, simply by configuring transceivers to accommodate more layers. Practical restrictions could occur which heavily depend on base station type and the traffic volumes for each layer.

Traffic Steering: Mutual Use of Resources Between Layers

Introduction

Illustratively, two separate and independent layers are created within one physical network (using, e.g., the embodiments of FIGS. 5-7). It is possible to mutually use circuit switched resources, without losing the nature of two separate networks, by keeping terminals in idle mode on their particular layer. This implies that signalling resources, for instance using SMS, is also kept in the original layer. This is described in the next section. Finally, a Thin Layer variant is described through which a very efficient two-layer network can be created.

In this example, it is assumed that the radio network is not equipped with a working PBCCH.

Traffic steering is not required to create a two-layer 2G network. Traffic steering is only an add-on in order to use resources more efficiently than otherwise.

Idle Mode and CS Resources

To maintain a user's perception that ‘his’ or ‘her’ particular ‘network’ (here called layer) is used during operation of an embodiment according of the invention (see above), user terminals UE must be kept in idle mode on that particular layer. CS capacity is first used in a particular layer itself and, above a certain load, CS traffic is transferred from one layer to the other. This approach can be deployed either unidirectional or bi-directional, as indicated in FIGS. 8 and 9. FIG. 8 schematically depicts unidirectional CS traffic steering from the second layer (layer 2) to the first layer (layer 1). FIG. 9 shows Bi-directional Traffic steering. Idle modes, in both figures, are schematically depicted by circular boxes “idle”, and active (voice) modes by circular boxes “Active Voice”. Arrows show various mode transitions.

Idle Mode

To maintain the perception for the end user to use ‘his’ or ‘her’ network (with a second network user terminal UE2), which is the second layer (layer 2) in the present example, a transition in idle mode (transition 1) must be actually blocked. How blocking can be achieved is described below.

Call Set-Up and Call Termination in Layer 2

A call can be set-up and terminated in layer 2 as usual. This is represented with transitions 2 and 3, in FIG. 8. A precondition is that free capacity must exist for this call.

Transfer CS Call with Handover

A call can be set-up in layer 2 as usual (transition 2) and can be transferred to layer 1 with a forced inter-PLMN handover (transition 4). A precondition is that the network supports inter-PLMN handover functionality and that handover relation is defined from the cell in layer 2 to the cell in layer 1. Free capacity must exist in layer 2 for a short time and for the remainder of the call in layer 1. How the handover is forced is explained below. Even in a situation where roaming is not allowed in layer 1 for layer 2 user terminals (UE2), the transfer of layer 2 traffic with a handover to layer 1 is still possible. At handover evaluation, no checks are done with respect to network identities.

Transfer of CS Call with Directed Retry

A call can be set-up by using call set-up signalling in layer 2 and a direct allocation of CS resources (traffic channel, or TCH) in this layer. The transition, shown in FIG. 8, is indicated by reference numeral. This mechanism is called a “directed retry”. Availability of inter-PLMN functionality and a relation from the cell in layer 1 to the cell in layer 2 must exist as preconditions. How the handover is forced is explained below.

Call Termination in Layer 1

After finalizing a call by the end user, while connected (with the terminal UE2) to layer 1, the terminal UE2, at call termination, must jump from active mode in layer 1 to idle mode in layer 2 (transition 6). Call termination is potentially possible via (i) direct jump, (ii) PLMN search or (iii) via idle mode in layer 1. The most convenient way is to use the direct jump option (i). Mobility within layer 1 is relevant in this perspective as well as possibly the contents of the forbidden PLMN list on SIM.

Blocking Transfer of Idle Mode Terminals

Blocking transfer of idle mode user terminals UE (i.e., terminals UE that are in their idle modes) can be achieved in several ways, for example by: (i) disallowing (national) roaming in layer 1 for terminals with HPLMN code of layer 2, (ii) blocking the broadcast on layer 2 of the idle mode neighboring cell list containing cells of layer 1 and (iii) influencing cell reselection criteria (C1 criteria) for idle mode cell reselections from layer 1 to layer 2.

An optimal way to block transfer of idle mode terminals is to use method (i) (disallowing (national) roaming in layer 1 for terminals with HPLMN code of layer 2), because this entirely blocks idle mode use in layer 1 by layer 2 terminals, where method (ii) allows idle mode use, depending on coverage differences between layer 1 and 2. However, in ideal coverage (one-to-one) no idle mode use in layer 1 occurs. If national roaming is desired, next to a dual-layer GSM architecture, method (ii) (blocking the broadcasting on layer 2 of the idle mode neighboring cell list containing cells of layer 1) can be used, though in any other case method (i) is preferable.

Forcing CS Traffic from Layer 2 to Layer 1

To force CS traffic from layer 2 to layer 1, network features must be available which are able to steer traffic, based on triggers, to be set in the network. Those features do not exist in ETSI/3GPP standards but are widely available as proprietary features implemented by specific radio network vendors. The features are widely used to steer traffic for other purposes in a network layer or between network layers to remedy network spots that exhibit high traffic congestion probabilities. Every radio network vendor implements such features and with every network forced steering of traffic can be arranged. The following main radio network features—generally described—are feasible to use:

Directed Retry (DR)

Directed Retry is already described above (transition 5 in FIG. 8). A target cell at a Directed Retry is usually blind, thus a handover is highly likely to fail. Furthermore, a DR is triggered at congestion. While this feature works, however, for reasons given below, it is not the most convenient feature.

Direct Access (DA)

Direct Access is considered as directed retry, but initiated after exceeding a certain load threshold in the cell, which is used at call set-up. Furthermore, the target cell for DA is not blind and can be defined. This feature is very feasible to use.

Traffic Reason Handover (TRH)

Traffic Reason Handover is a handover, so transition 2 and 4 of FIG. 8 will be used. Due to the available resources in a source cell, calls can be handed over to defined target cells. The feature is feasible to use, however, compared with DA, first a call will be set-up in an original layer.

The best feature to use (i.e., RD, DA or TRH) depends on performance and interference with respect to use of those features for other purposes.

Unidirectional Versus Bi-Directional Steering

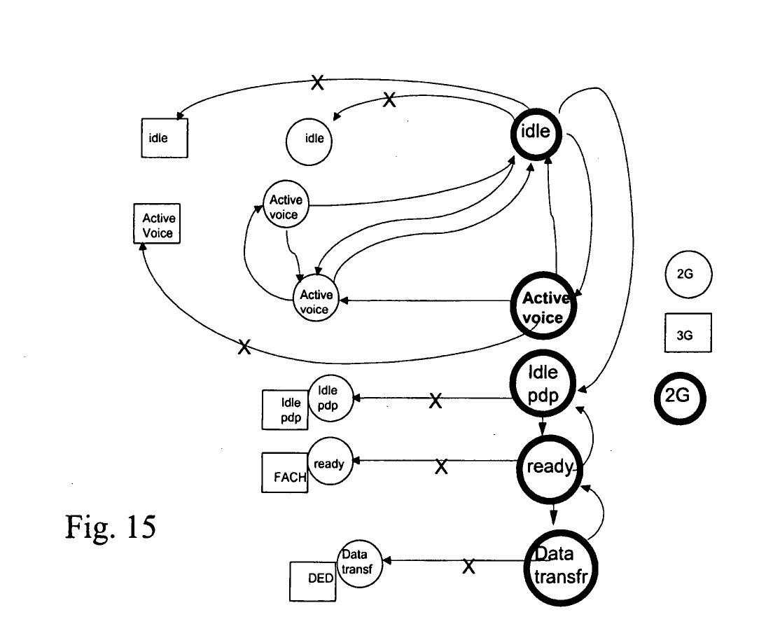

Unidirectional steering can be achieved to block transfer in idle mode, and transfer for CS traffic and PS traffic entirely in one direction. Idle mode and PS traffic are already described above. Blocking CS traffic is simply achieved by not configuring handover relations from layer 1 to layer 2. A total overview of all states in this case is given in FIG. 15. Capacity management is still rather simple in a unidirectional situation.

Bi-directional steering is also possible by mutually allowing CS traffic. Two considerations exist. First, due to coverage issues, further described later, transfer of CS traffic originated in layer 2 is possible between layer 1 to layer 2. This can be avoided by using a one-to-one network as described later. Second, capacity management can be more difficult when allowing bi-directional traffic.

Mobility

As to maintaining the mobility in each layer, from FIGS. 8 and 9, mobility can be maintained on each layer (intra-layer mobility) for corresponding end user terminals. Furthermore, mobility is also assured for terminals which are steered to another layer. In principle, inter-layer mobility can be arranged, however it is not the primary aim to steer traffic to provide mobility.

Display Problem

With respect to the display problems solved by the two-layer (or alternatively multiple-layer) concept (as in FIGS. 5-7), which terminal UE is kept on a certain layer in idle mode, the display shows the right brand name (as explained above regarding FIG. 14). In the present embodiment, the name in the display (according SE13 list) only depends on information received in idle mode and not in active mode. That means that after transfer of a call to another layer (of the network, containing the layer), the display will not change. The end user perception therefore, is that the network of the idle mode layer is used.

PS Resources

In principle, cell reselection for PS traffic works essentially the same as cell reselection in idle mode. In most networks, the actual switching criteria parameters are equal for idle mode and PS cell reselection. Then, PS traffic steering between layers, while keeping terminals in an idle mode, is simply not possible. By splitting those parameters, Network Controlled Cell Reselections (NCCR) can then be used to control PS traffic apart from idle mode behavior of terminals.

Many situations do not require steering PS traffic from one layer to another since the total PS volume in one 2G network (e.g., GPRS) is far less when compared to CS traffic volumes. Therefore, steering CS traffic is usually enough by itself to create an efficient two-layer network (see the described example of a Thin Layer variant below).

For a total overview of states, see FIG. 15. FIG. 15 shows a traffic state steering diagram where 2G modes are shown by circles and 3G modes by squares.

Remaining Resources

Resources, not used in idle mode or used for PS and CS traffic and (particularly always) related to a BCCH TRX, remain in each layer separately due to configuration of a dedicated BCCH TRX for each layer.

The remaining resources are those used for signalling purposes not related to a call and transfer of SMS, like PAGCH, RACH, FCCH, SCH, AGCH, PCH, SDCCH, CBCH, etc, so any logical channel, related to a BCCH TRX (see “‘The GSM System for Mobile Communications’, Michel Mouly & Marie-Bernadette Pautet, CELL&SYS, 1992, ISBN 2-9507190-0-7”, which is incorporated by reference herein, for more detailed information).

Thin Layer Variant

The need for a solution to the problem of absorption of users on an “alien” network into another network, as explained in the introduction of this application, can lead to a dual-layer variant of the invention, which is called a “Thin Layer”.

As an example, a starting point is to design a dual-layer 2G network with an existing network (called network 1), containing approximately 3500 sites with 10,000 cells where absorption is desired of subscribers of a second network 2, containing approximately 2600 sites and 7500 cells. Network 1 uses 900 MHz for their main umbrella network and GSM1800 as capacity layer on spots with high traffic volumes. Network 2 was working on 1800 Mhz and extended 900 MHz (EGSM) licenses were also available.

In an existing network, as few as possible TRXs are added or reconfigured to create a second layer. The number of TRXs locally applied on depends depending on PS traffic which must fit into layer 2.

Illustratively, in every case only one additional TRX is required to create a second layer and absorb the subscribers of network 2. Traffic steering for CS traffic is applied unidirectional from layer 2 to layer 1. The result is a “thin layer”.

Several derivatives are possible:
one-to-one network: All sites are equipped with a second layer. Inter-PLMN handover relations can be easily handled. Coverage of layer 2 is, on average, considerably better when compared with that of network 2, however local deviations exist but can be retuned.
umbrella network: Hence, only approximately 1500 sites are equipped with a second layer, thus yielding a less expensive solution. However, it is more difficult to handle inter-PLMN RELATIONS. Thus yielding the coverage of layer 2 on average the same as that for layer 1, but local deviations exist which, with difficulty, can be retuned.

Furthermore, we can differentiate among these derivatives depending the above derivates, depending on use of frequency band:
Use EGSM for layer 2: No additional interference results, so no equivalent capacity is required for compensation.
Use GSM900 frequencies from layer 1 also in layer 2: Additional interference has to be compensated. Two methods can be used to handle this: (a) shift traffic to the GSM1800 layer, or (b) deploy AMR HR to save use of frequencies.

Base Station Sharing Using the Invention

According to embodiments, some base station configurations are known, particularly with regard to coupling several transceivers and using cross-connects for transmission by itself. What distinguishes the invention, is that here two different pools for each network layer are used. With the example of base station implementations below, insight is given how to build a multilayer mobile network and derivatives of such network.

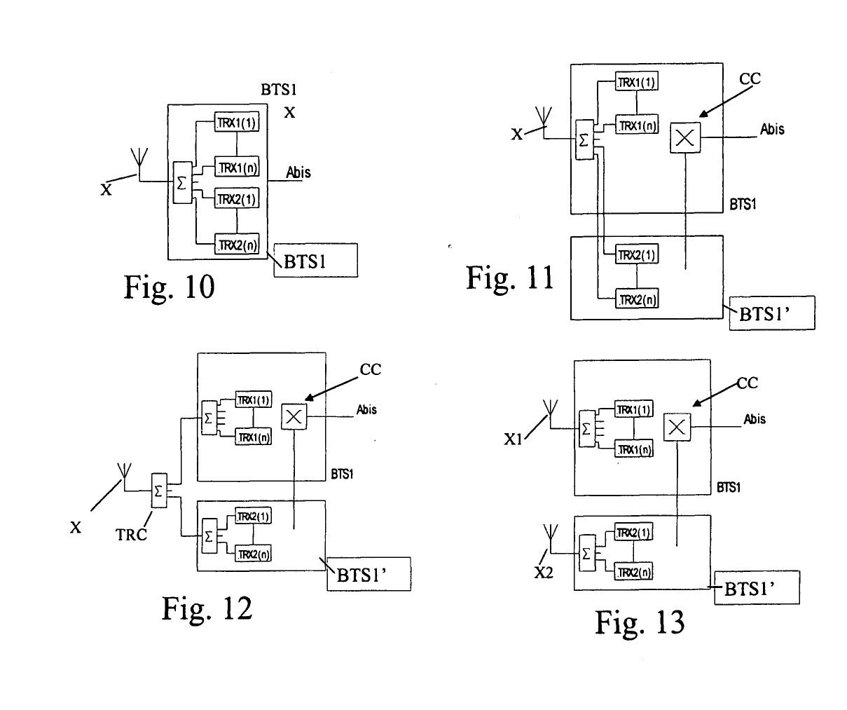

FIGS. 10-13 assume an existing base station with one TRX pool. Since base station typically contain three sectors, these four figures are valid for each separate sector within the base station.

FIG. 10 shows an implementation of an existing base station—which is also used in FIGS. 5-7. Particularly, FIG. 10 shows a mobile network base station BTS having a number of first transceivers TRX1 configured for a first network layer relating to a first network identity HPLMN1, and a number of second transceivers TRX2 configured for a second network layer relating to a second network identity HPLMN2.

Depending on capacity requirements and available capacity, several existing TRXs of the base station BTS1 can be reconfigured for a second layer, or TRXs can be added to create the second layer. Preferably, one or more existing transmitter and receiver couplers (indicated by the Σ symbol) inside the base station BTS1 are used, as well as the entire antenna installation X of the base station BTS1. This implies that the same frequency band must be used for layer 1 and layer 2. The total capacity requirements may not exceed the total capacity availability of the base station. The coverage for layer 1 and coverage for layer 2 are not affected. Transmission can be shared without any modification. Possible base station extensions will now be considered.

FIG. 11 differs from FIG. 10 in that the former contains an additional base station BTS1′ added to the existing couplers Σ of the first base station BTS1. Here a mobile network base station BTS1 has a number of first transceivers TRX1 configured for a first network layer relating to a first network identity HPLMN1, and a cross-connect CC to share transmission with a second base station BTS1′, the second base station having a number of second transceivers TRX2 configured for a second network layer relating to a second network identity HPLMN2. The cross-connect CC couples an interface (Abis) leading to a base station controller BSC1 (see FIGS. 5-7), to the second base station BTS1′.

With the implementation shown in FIG. 11, an additional base station BTS1′ is used, but this is coupled with transmitter and receiver couplers Σ in the existing base station BTS1, so that coverage for layer 1 and layer 2 is not affected. The same frequency band must be used. Usually, this is suited to create a second layer on sites which require additional capacity. Transmission can be easily shared by using cross-connect CC in the base station BTS1. Cross-connect CC is, in most base stations, available for multi-drop (cascading) purposes, otherwise it needs to be separately added. As follows from FIG. 11, the same antenna X (of the first base station) is used for transmission of the various network identities HPLMN1 and HPLMN2.

FIG. 12 shows an embodiment, which differs from that shown in FIG. 11 in that the former has additional couplers TRC. Particularly, there are additional transmitter and receiver couplers TRC outside (i.e., external to, or being separate from) the two base stations BTS1 and BTS1′. Also, each base station BTS1 and BTS1′ has its own couplers E. For example, couplers E of both base stations BTS1 and BTS1′ are coupled to the additional couplers TRC leading to the same antenna X. This is feasible in situations where no free coupler connections in the existing base station can be used. A drawback of this configuration is that additional signal loss is introduced at the transmitter and receiver paths. In most cases, an uplink (receiving) path is a limited factor in network coverage. A practical solution is to use a diversity port for receiver coupling in the existing base station, though the transmitters of both base stations are coupled as shown. The receiving losses then depend on the radio environment of the corresponding site. In this configuration, the same frequency band must be used. Transmission is shared by using cross-connect CC (leading to the Abis interface).

FIG. 13 shows another embodiment, which differs from that shown in FIG. 11 in that the former has two base stations BTS1 and BTS1′ with separate antennas X1 and X2 (the first base station BTS1 having first antenna X1 and the second base station BTS1′ having second antenna means X2). An additional base station can be used as well as separate antenna installations. In that case, a different frequency band for each layer can be deployed. Transmission sharing is arranged via a suitable cross-connect CC (that can be part of the first base station BTS1, for example).

Network Quality: Coverage and Capacity

Coverage

According to embodiments, to create an additional layer in an existing network, several variants of the invention could be deployed (as also discussed above):
one-to-one network: At every site of the existing network, a second layer is implemented. If traffic steering is deployed, a one-to-one inter-PLMN relation is made between the layers. If the same frequency band for each layer is used, the coverage is entirely equal for each layer.
umbrella network: The same area is covered with a second layer but only with a portion of the sites. The coverage-capacity density of the added layer is less than that of the original network. If traffic steering is deployed, more handover relations must be managed in the network.

With regard to coverage, within the area of an existing network, geographical restrictions can be made to add a second layer. The original corresponding network of layer 2 can be left in place outside the dual-layer area. In that case, attention should be paid to the seamless transfer of traffic between the areas, where the layer 2 original network remains and the area with a second layer in an alien network.

### Capacity for Traffic

Dimensioning capacity in a dual-layer mobile network according to the invention, but without use of traffic steering, can be achieved. With regard to dimensioning base station TRX capacity, two entirely independent capacity entities are to be dimensioned. To determine capacity for BSCs and core network elements, the traffic of both layers can be added to each other.

In case traffic steering is deployed, dimensioning for capacity in base stations needs to be addressed. For unidirectional dual networks, only one stream has to take into account, but for bi-directional networks, two streams need to be considered. The dimensioning itself falls outside the scope of this application and thus will not be discussed any further.

Use of frequencies: equivalent capacity for interference compensation. From the prior discussion, for a very efficient dual-layer (or multi-layer) network, the same frequencies band for layers 1 and layer 2 (or one or more further additional layers) are used.

A second layer can require use of at least a BCCH TRX per site. The difference of a BCCH TRX, compared for a TRX, which is only used for traffic channels, is that such BCCH TRX is transmitting continuously. This could result in additional interference.

In case the same frequency band is used for layers 1 and 2, a question is whether frequencies for layer 2 can be added to frequencies, which are already used for layer 1. In this particular situation, an increase in interference is not an issue. However, if the same number of frequencies must be used out of layer 1 to create layer 2, an increase of interference occurs, as well as possible loss, due to the fact that a frequency for BCCH cannot be a hopping frequency. This interference is preferably compensated by, e.g., utilizing Half Rate (HR) and/or Adaptive Multi Rate (AMR). Also, a shift of a certain amount of traffic to capacity layers can be used.

Multi-Layer 3G Network According to the Invention

As noted previously, for 3G, some features for network sharing are standardized with 3GPP. Those features are based on one WCDMA carrier or set of carriers for multiple PLMNs. The 3GPP features are different compared to embodiments of multi-layer 2G concepts according to the invention.

Despite the very efficient 3G standardized network sharing methods, there could be very good reasons for also deploying a multi-layer architecture according to the invention in a 3G environment. A principle reason is that network sharing is desired, but with use of separate frequencies, due to meeting certain license conditions and assigned by local authorities.

A multi-layer 3G network is similar to a multi-layer 2G network. Therefore, almost all details given for 2G are also valid for 3G. In a multi-layer 3G network, different WCDMA carriers or set of WCDMA carriers are defined for each PLMN. The following sections described above for 2G are directly applicable for 3G also:
General description of two-layer or multi-layer architecture;
Separate core network variant;
Multiple-layers;
Typical implementations for base station sharing;
Coverage; and
Capacity for traffic, except the part about traffic steering.

Although the illustrative embodiments of the present invention have been described in detail with reference to the accompanying drawings, it will be understood that the invention is not limited to those embodiments. Various changes or modifications may be effected by one skilled in the art without departing from the scope or the spirit of the invention as defined in the claims.

Further in the present application, each of the terms “comprising” and “having” do not exclude other elements or steps. Also, each of the terms “a” and “an” do not exclude a plurality. Also, a single processor or other unit may fulfill functions of several means recited in the claims. Any reference sign(s) in the claims shall not be construed as limiting the scope of the claims. Also, in this application, the terms “customers”, “subscribers” and “users” can have similar meaning.

### LIST OF ABBREVIATIONS

AGCH Access Grant Channel

AMR Adaptive Multi Rate

APN Access Point Name

BCCH Broadcast Channel

BTS Base Station

CBCH Cell Broadcast Channel

Cell ID Cell Identity

CGI Cell Global Identity

CS Circuit Switched

DA Direct Access

EGSM Extended GSM

FCCH Frequency Correction Channel

GPRS General Packet Radio Services

HPLMN Home Public Land Mobile Network

HR Half Rate

LAC Location Area Code

MCC Mobile Country Code

MNC Mobile Network Code

NCCR Network Controlled Cell Reselection

NR National Roaming

OSS Operation Sub System

OTA Over-The-Air

PAGCH Paging Access Grant Channel

PBCCH Packet Broadcast Channel

PLMN Public Land Mobile Network

PS Packet Switched

RACH Random Access Channel

SCH Synchronization Channel

SDCCH Standalone Dedicated Control Channel

SIM Subscriber Identity Module

SMS Short Message Services

TCH Traffic Channel

TL Thin-Layer

TRH Traffic Reason Handover

TRX Transceiver

UE User Equipment

WCDMA Wideband Code Division Multiple Access

BSC Base Station Controller

MSC Mobile Switching Centre

HLR Home Location Register

SGSN Serving GPRS Support Node

IMSI International Mobile Subscriber Identity

GMSC Gateway Mobile Switching Centre

GGSN Gateway GPRS Support Node

1. A mobile network configured to broadcast at least a first network identity (HPLMN1) and a second network identity (HPLMN2) and to provide first and second network layers.

2. The network recited in claim 1 wherein the network is a Home Public Land Mobile Network (HPLMN), the first network identity (HPLMN1) is a first Home Public Land Mobile Network code, and the second network identity (HPLMN2) is a second Home Public Land Mobile Network code.

3. The network recited in claim 1, further comprising at least one Base Station (BTS), having a number of transceivers (TRX), configured to broadcast the at least first and second network identity, one or more of the first transceivers (TRX1) being configured to broadcast the first network identity and one or more second transceivers (TRX2) being configured to broadcast the second network identity.

4. The network recited in claim 3 further comprising:
one or more Base Station Controllers (BSC) connected to the at least one Base Station (BTS) via a respective interface (Abis), each of the Base Station Controllers being configured to handle the at least two network codes (HPLMN1, HPLMN2);
a Mobile Switching Centre (MSC) and Serving GPRS Support Node (SGSN) that are both configured to handle the at least two network codes.

5. The network recited in claim 1 further comprising at least one antenna to transmit both the first and second network identities.

6. The network recited in claim 1 further comprising a network architecture configured to provide a first layer relating to the first network identity and a second layer relating to the second network identity, wherein the layers are separate and independent of each other.

7. The network recited in claim 1 wherein the first network identity contains a first Mobile Country Code (MCC1) and a first Mobile Network Code (MNC1), the second network identity contains a second Mobile Country Code (MCC2) and a second Mobile Network Code (MNC2), the second Mobile Network Code (MNC2) being different from the first Mobile Network Code (MNC1).

8. The network recited in claim 1 comprising a first service platform associated with the first network code and a second service platform associated with the second network code, and a packet switching core (Core PS 1) and a circuit switching core (Core CS 1), wherein the first and second service platforms are each connected to the packet switching core and to the circuit switching core.

9. A mobile network base station (BTS) comprising a number of first transceivers (TRX) configured for a first network layer relating to a first network identity (HPLMN1), and a number of second transceivers (TRX2) configured for a second network layer relating to a second network identity (HPLMN2).

10. A mobile network base station (BTS1) comprising a number of first transceivers (TRX) configured for a first network layer relating to a first network identity (HPLMN1), and a cross-connect (CC) to share transmission with a second base station (BTS1′), the second base station comprising a number of second transceivers (TRX2) configured for a second network layer relating to a second network identity (HPLMN2).

11. A method to register a mobile terminal on a network, the network configured to broadcast at least a first network identity (HPLMN1) and a second network identity (HPLMN2) and to provide first an second network layers, the method comprising the steps of:
broadcasting, through the network, the first network identity and the second network identity;
receiving the first and second network identifies at the mobile terminal;
registering the mobile terminal on the network when a received network identity corresponds with an individual mobile subscriber identity (IMSI) of a respective subscriber of the terminal.

12. A method to provide a mobile network, the network configured to broadcast at least a first network identity (HPLMN1) and a second network identity (HPLMN2) and to provide first and second network layers the method comprising the steps of:
providing a first mobile network configured to broadcast the first network identity using a respective first network layer; and
providing the first mobile network at least with a second network layer for using the second network identity relating to an alien network.

13. The method recited in claim 12 wherein a multiple-layer network architecture is used in the first network to discard the alien, network.

14. The method recited in claim 12 further comprising the steps of:
maintaining the perception of a certain user, that ‘his’ or ‘her’ particular layer is used, by keeping a respective user terminal (UE) in an idle mode on said particular layer, by blocking layer transition during the idle mode.

15. The method recited in claim 12 further comprising the steps of blocking a transfer of an idle mode user terminal (UE) from a second layer to a first layer, by any of the following steps:
(i) disallowing roaming in the first layer for terminals with a network identification code of the second layer;
(ii) blocking broadcasting on the second layer of an idle mode neighboring cell list containing cells of the first layer; and
(iii) influencing cell reselection criteria (C1 criteria) for idle mode cell reselections from the first layer to the second layer.

16. The method recited in claim 12 further comprising the steps of:
using a circuit switching (CS) capacity in a particular layer itself first; and
transferring circuit switching (CS) traffic, above a certain load, from one layer to the second layer.

17. The method recited in claim 12 further comprising the steps of:
setting up a call; and
transferring the call from one layer to the second layer using a forced PLMN handover.

18. The method recited in claim 12 further comprising the step of setting up a call by using call set-up signalling in the second layer, and a direct allocation of CS resources in the second layer.

19. The method recited in claim 12 further comprising the step of terminating a call in the first layer, wherein at call termination a jump from an active mode in the first layer to an idle mode in the second layer occurs.

20. Use of the method recited in claim 12 wherein the second network layer is provided for taking over alien customers in the first mobile network, wherein in the first network the second network identity (HPLMN2) is broadcasted, with the second identity being equal to the alien network identity.
